(19) United States
(12) Patent Application Publication
(10) Pub. No.: US 2003/0056625 A1
(43) Pub. Date: Mar. 27, 2003

(54) Output shaft and concentrically mounted attachments therefor

(76) Inventors: Paul K. Bizilia, sayre, PA (US); Thomas R. Quattrini, Sayre, PA (US); Donald R. Warner, Columbia Crossroads, PA (US)

Correspondence Address: MICHAEL BEST & FRIEDRICH LLP, 3773 CORPORATE PARKWAY, SUITE 360, CENTER VALLEY, PA, 18034-8217, US

(21) Appl. No.: 09/957,873

(22) Filed: Sep. 21, 2001

(51) Int. Cl. B25B 23/16

(52) U.S. Cl. 81/177.85

(57) ABSTRACT

An output shaft and attachment combination and a power tool incorporating the combination are disclosed. The output shaft has a first diameter portion, a second diameter portion, and a drive portion located between the first and second diameter portions. The attachment has a first cylindrical bore, a second cylindrical bore, and a driven bore located between the first and second cylindrical bores. The first cylindrical bore and the second cylindrical bore have inner diameters sized to receive outer diameters of the first diameter portion and the second diameter portion, respectively. The driven portion is configured to engage the drive portion.

### BACKGROUND OF THE INVENTION

This invention relates generally to handheld and power tools. More particularly, this invention relates to alignment and vibration reduction of an attachment, such as sockets and extensions, coupled to another attachment, such as an extension, or the output shaft such as an anvil, of a handheld or power tool.

Coupling attachments (e.g., sockets and extensions) to another attachment (e.g. extension) or an output shaft (e.g., an anvil) of a power tool (e.g., impact wrench, nutrunner, or pulse tool) is commonly achieved by mating a bore in the attachment with the drive of an extension or the output shaft of the power tool. A recurring difficulty with the coupling (e.g., socket-output shaft, extension-output shaft, and socket-extension) of these attachments is that typically large tolerances exists or are formed between the bore of the attachment and the output shaft of the power tool. Loose tolerances allow undesirable alignment between the tool and the fastener and undesirable vibration and run out to occur at the attachment.

Some of the difficulties associated with loose tolerances include: erratic rotation of the attachment due to improper alignment; surface wear of the attachment at a fastener/socket interface; surface wear at an attachment/attachment interface; surface wear at an attachment/output shaft (of the power tool) interface; and reduced life of the power tool due to the associated vibrational stresses; and misalignment and torque. Surface wear at any of the above interfaces reduces the effectiveness of the power tool by reduced alignment, increased vibration, and reduced torque.

Most sockets and extensions on the market today are adapted to engage only the square drive portion of the output shaft of a power tool. As a result, one disadvantage is that close machining tolerances are required to produce square drive portions that accurately fit into and reduce excessive play when inserted into a socket or extension. Another drawback is that present drive/extension/socket combinations available today are not adequate for high rotational speeds that are generally required, for instance, in the racing industry.

The foregoing illustrates limitations known to exist in present power tools and attachments therefor. Thus it is apparent that it would be advantageous to provide an alternative directed to overcoming one or more of the limitations set forth above. Accordingly an alternative output shaft and attachment combination are provided including the features more fully disclosed hereinafter.

### SUMMARY OF THE INVENTION

According to the present invention, an output shaft and attachment combination and a power tool incorporating the combination are disclosed. The output shaft has a first diameter portion, a second diameter portion, and a drive portion located between the first and second diameter portions. The attachment has a first cylindrical bore, a second cylindrical bore, and a driven bore located between the first and second cylindrical bores. The first cylindrical bore and the second cylindrical bore have inner diameters sized to receive outer diameters of the first diameter portion and the second diameter portion, respectively. The driven portion is configured to engage the drive portion.

The foregoing and other aspects will become apparent from the following detailed description of the invention when considered in conjunction with accompanying drawing figures.

### BRIEF DESCRIPTION OF THE DRAWINGS

These and other advantages of the present invention will become more readily apparent upon reading the following detailed description and upon reference to the drawings in which:

FIG. 1 is a isometric view of an output shaft and attachment according to the present invention;

FIG. 2 is a cross-sectional view of the output shaft and attachment shown in FIG. 1; and

FIG. 3 is a cross-sectional view of the output shaft and attachment shown in FIG. 2 shown assembled in its operative mode.

### DETAILED DESCRIPTION OF THE PREFERRED EMBODIMENTS

The invention is best understood by reference to the accompanying drawings in which like reference numbers refer to like parts. It is emphasized that, according to common practice, the various dimensions of the component parts as shown in the drawings are not to scale and have been enlarged for clarity.

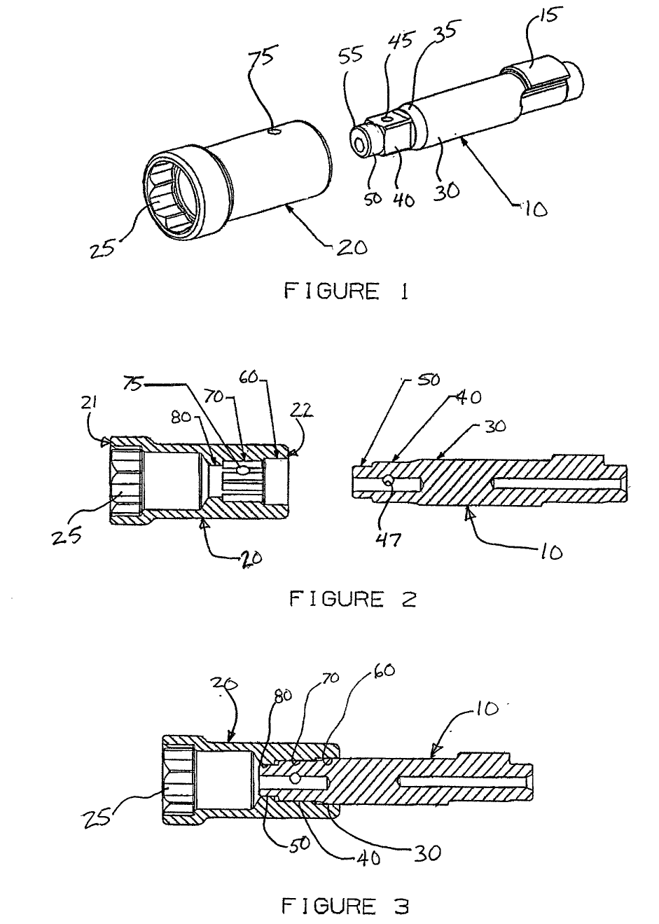

Referring now to the drawings, there is shown in FIGS. 1-3 an output shaft and concentrically mounted attachment according to the present invention. An attachment 20, in this case a socket for a power tool, and an output shaft 10 are shown. In preferred embodiment of the present invention as shown, output shaft 10 is preferably attached to an anvil 15 for use in an impact tool and may be of the type shown in commonly assigned U.S. Pat. No. 5,346,024 issued to Geiger et al., the disclosure of which is incorporated by reference herein. When used in such a manner, output shaft 10 extends beyond the housing of a power tool (not shown) when mounted therein and is the driven member that delivers torque to an object to be rotated such as a threaded fastener.

As shown best in FIGS. 1 and 2, output shaft 10 comprises a drive portion 40, typically square in shape, and preferably a retaining device 45 to hold attachment 20 on output shaft 10. Retaining device 45 may be a ball extending from one side of the square drive portion as shown that, normally, is held in an outward position by an internal spring (not shown) mounted in a radial bore 47. Upon inserting output shaft 10 into attachment 20, the ball of retaining device 45 is depressed until it reaches and extends radially outward to engage a corresponding radial bore 75 that is perpendicular to a driven bore 70, as is known in the art. A first diameter portion 30 and a second diameter portion 50 are provided in concentric, axial alignment along output shaft 10 with drive portion 40 being located between the first and second diameter portions. Preferably, second diameter portion 50 is smaller than first diameter portion 30 in order to facilitate the piloting of output shaft 10 into attachment 20 as described in greater detail below. To further facilitate the piloting of the drive shaft 10 into attachment 20, a first chamfer 35 and a second chamfer 55 are most preferably provided on first diameter portion 30 and second diameter portion 50, respectively, as shown.

As shown best in FIG. 2, attachment 20 comprises a first end 21 and a second end 22. In a preferred embodiment, the first end 21 is a socket having an inner bore 25. The most common shape of the inner bore 25 is a hex shape, however, other shapes, such as octagonal, twelve point or splines, are also known in the art. The first end 21 may also be any other tool end commonly known to work on a threaded fastener.

The second end 22 comprises two concentric cylindrical bores, namely, a first cylindrical bore 60 and a second cylindrical bore 80, that are in axial alignment and have driven bore 70 located between the first and second cylindrical bores. First cylindrical bore 60 and second cylindrical bore 80 are pilot diameters that are located axially within attachment 20 to receive, respectively, first diameter portion 30 and second diameter portion 50 located on output shaft 10.

Driven bore 70 is adapted to mate with drive portion 40 of output shaft 10, and is therefore typically square in shape. By using mating concentric cylinders provided by second diameter portion 50/second cylindrical bore 80 and first diameter portion 30/first cylindrical bore 60 at the front and rear of drive portion 40/driven bore 70, respectively, concentricity of the socket relative to the anvil may be held to much closer tolerances thus permitting the square drive portion to be used only as a means for driving the socket. Thus, a slip fit or mild interference fit between driven bore 70 and drive portion 40 is the desired fit so that the power tool attachments may be readily interchanged. As a result, by reducing the need for a square drive portion and a driven bore having close mating tolerances, the present invention to provides easier assembly/disassembly of an attachment 20 from an output shaft 10. Moreover, because modem machining practices can maintain closer tolerances when fabricating diameters than square surfaces, both the manufacture of and the ultimate fit of the drive and attachment parts is greatly improved.

While embodiments and applications of this invention have been shown and described, it will be apparent to those skilled in the art that many more modifications are possible without departing from the inventive concepts herein described. For example, although in FIGS. 1-3 output shaft 10 is shown attached to an anvil 15 for use in a power tool, it will be readily recognized by those skilled in the art that the output shaft may be configured for use with a handle for a hand driven tool. Additionally, although attachment 20 is shown in FIGS. 1-3 as a socket, as will be readily recognized by those skilled in the art, attachment 20 may also be an extension or any other tool adapted for attachment to output shaft 10. It is understood, therefore, that the invention is capable of modification and therefore is not to be limited to the precise details set forth. Rather, various modifications may be made in the details within the scope and range of equivalents of the claims without departing from the spirit of the invention.

What is claimed is:

1. An output shaft and attachment combination comprising:
an output shaft having a first diameter portion, a second diameter portion, and a drive portion located between said first and second diameter portions, and
an attachment having a first end and a second end, said second end having a first cylindrical bore, a second cylindrical bore, and a driven bore located between said first and second cylindrical bores,
said first cylindrical bore and said second cylindrical bore having inner diameters sized to receive outer diameters of said first diameter portion and said second diameter portion, respectively, and said driven portion being configured to engage said drive portion.

2. The output shaft and attachment combination according to claim 1, wherein said output shaft further comprises an anvil.

3. The output shaft and attachment combination according to claim 1, wherein said drive portion and said driven bore have mating square cross-sections.

4. The output shaft and attachment combination according to claim 1, wherein said drive portion further comprises a retaining device to hold said attachment on said output shaft.

5. The output shaft and attachment combination according to claim 4, wherein said retaining device is a ball extending from one side of said drive portion and held in an outward position in a radial bore located in said drive portion.

6. The output shaft and attachment combination according to claim 5, wherein said attachment comprises a radial bore perpendicular to said driven bore, said radial bore configured to engage said ball when said output shaft is inserted in said attachment.

7. The output shaft and attachment combination according to claim 1, wherein said second diameter portion is smaller than said first diameter portion.

8. The output shaft and attachment combination according to claim 1, further comprising a first chamfer and a second chamfer provided on said first diameter portion and second diameter portion, respectively.

9. The output shaft and attachment combination according to claim 1, wherein said first end of said attachment is a socket having an inner bore.

10. The output shaft and attachment combination according to claim 9, wherein said inner bore is threaded fastener tool end shape configuration selected from the group consisting of a hexagon, an octagon, a twelve point, and a spline.

11. A power tool comprising:
an output shaft having a first diameter portion, a second diameter portion, and a drive portion located between said first and second diameter portions, and
an attachment having a first end and a second end, said second end having a first cylindrical bore, a second cylindrical bore, and a driven bore located between said first and second cylindrical bores,
said first cylindrical bore and said second cylindrical bore having inner diameters sized to receive outer diameters of said first diameter portion and said second diameter portion, respectively, and said driven portion being configured to engage said drive portion.

12. The power tool according to claim 11, wherein said output shaft further comprises an anvil.

13. The power tool according to claim 11, wherein said drive portion and said driven bore have mating square cross-sections.

14. The power tool according to claim 11, wherein said drive portion further comprises a retaining device to hold said attachment on said output shaft.

15. The power tool according to claim 14, wherein said retaining device is a ball extending from one side of said drive portion and held in an outward position in a radial bore located in said drive portion.

16. The power tool according to claim 15, wherein said attachment comprises a radial bore perpendicular to said driven bore, said radial bore configured to engage said ball when said output shaft is inserted in said attachment.

17. The power tool according to claim 11, wherein said second diameter portion is smaller than said first diameter portion.

18. The power tool according to claim 11, further comprising a first chamfer and a second chamfer provided on said first diameter portion and second diameter portion, respectively.

19. The power tool according to claim 11, wherein said first end of said attachment is a socket having an inner bore.

20. The power tool according to claim 19, wherein said inner bore is threaded fastener tool end shape configuration selected from the group consisting of a hexagon, an octagon, a twelve point, and a spline.
